(19) United States
(12) Patent Application Publication
(10) Pub. No.: US 2008/0164784 A1
(43) Pub. Date: Jul. 10, 2008

(54) Step-by-step motor able to carry out up-and-down motion

(76) Inventor: Hsiu-Ming Huang, Yongkang City (TW)

Correspondence Address: Hsiu-Ming HUANG, P.O. BOX 90, Tainan City, 70499, omitted

(21) Appl. No.: 11/649,260

(22) Filed: Jan. 4, 2007

(51) Int. Cl. H02K 37/00; H02K 5/04; H02K 5/16

(52) U.S. Cl. 310/49 R; 310/89

(57) ABSTRACT

A step-by-step motor able to carry out up-and-down motion includes a housing, a connecting base, a top rod, a bearing, a connecting member, a magnet, a right-handed coil, a reverse coil and a bottom cover combined together. The housing has one side bored with an opening and its inner wall bored with a slide groove, and the connecting base has one outer wall formed with a slide rail for combining the connecting base on the outer wall of the housing. The bottom cover is provided with an annular recess for engaging the bottom edge of the housing, and then the bottom cover and the housing are firmly combined together by supersonic welding. By so designing, the step-by-step motor can be assembled conveniently, quickly and stably.

### BACKGROUND OF THE INVENTION

1. Field of the Invention

This invention relates to a step-by-step motor able to carry out up-and-down motion, particularly to one assembled by having the slide rails of a combining base respectively inserted in the slide grooves of a housing and by supersonic welding, able to be assembled conveniently and stably.

2. Description of the Prior Art

The headlamp of an automobile is usually installed with a step-by-step motor for adjusting the radiating height of the headlamp. A conventional step-by-step motor, as shown in FIGS. 1, 2 and 3, includes a housing 10 provided with a positioning post 100 in the interior, and having one sidewall bored with an opening 101 and its upper edge formed with a plurality of positioning projections 102 spaced apart and extending upward. A connecting base 11 is secured on the outer wall of the opening 101 of the housing 10 by means of a bonding agent, with its topside disposed with a plurality of posts 110. A right-handed coil 12, a separating plate 13 and a reverse coil 14 are orderly overlapped and positioned in the interior of the housing 10. The right-handed coil 12 and the reverse coil 14 respectively have one side disposed with connecting terminals 120, 140 to be connected with the connecting base 11 and respectively have the inner circumferential wall provided with claws 121 and 141, and the separating plate 13 is bored with a through hole 130 in the center. A magnet 15, a bearing 16 and a connecting member 17 with female threads 171 are combined together by means of a retaining ring 170 and positioned in the center hole of the right-handed coil 12, of the separating plate 13 and of the reverse coil 14. A top rod 18 to be threadably assembled on the connecting member 17 has its lower section formed with threads 180, its intermediate outer wall fixed with a square positioning block 181 and its upper end provided with an upright post 182 with a transverse pin hole 183. A cover 19 to be closed on the housing 10 is bored with an insert hole in the center for the top rod 18 to be inserted therethrough and has its interior formed with a recessed chamber 191 for receiving the bearing 16 therein. The recessed chamber 191 is provided with a square positioning hole 192 for fitting the square positioning block 181 of the top rod 18. Further, the cover 19 has one lateral side bored with engage holes 193 corresponding with the posts 110 of the connecting base 11 and its circumferential wall cut with a plurality of notches 194 spaced apart for respectively engaging the positioning projections 102 of the housing 10 so as to combine the cover 19 and the housing 10 together. A locking knob 184 is mounted on the upright post 182 of the top rod 18 and has one side bored with a pin hole 185 for a pin 186 to be inserted therein to firmly assemble the locking block 184 on the top rod 18, thus finishing assembly of the step-by-step motor.

However, the connecting base 11 of the step-by-step motor 1 is fixed on the housing 10 by means of the bonding agent; therefore, after used for a long period of time, the bonding agent may lose its efficacy and the connecting base 11 is likely to fall off. In addition, the housing 10 is combined with the cover 19 by having its positioning projections 102 bent and respectively engaged in the notches 194 of the cover 19, with the positioning projections 102 likely to break when they are bent.

### SUMMARY OF THE INVENTION

The objective of this invention is to offer a step-by-step motor able to carry out up-and-down motion, able to be assembled conveniently and quickly.

The step-by-step motor able to carry out up-and-down motion in the present invention includes a housing formed in the interior with an accommodating chamber provided inside with a recessed chamber bored with a rectangular slot having its upper side bored with an insert hole. The housing further has one sidewall bored with an opening, and its inner wall cut with a slide groove. A connecting base to be assembled on the sidewall of the housing has one side formed with a slide rail and its interior provided with a plurality of connecting holes. A top rod to be inserted in the insert hole of the housing has a section near its lower end provided with male threads, its intermediate wall formed with a square stopper and its upper end assembled with a locking knob. A bearing is received in the recessed chamber of the housing. A connecting member positioned under the bearing has its upper end inserted in the bearing and its center bored with a threaded hole. A magnet is fitted around the connecting member. A right-handed coil to be positioned in the accommodating chamber of the housing has one outer side disposed with connecting terminals, and its inner and outer circumferential wall respectively covered with claws spaced apart. A reverse coil to be received in the accommodating chamber of the housing and overlapped with the right-handed coil has one outer side fixed with parallel connecting terminals, and its inner and outer circumferential wall respectively covered with claws spaced apart. A bottom cover to be closed on the bottom of the housing is bored with an annular recess near its circumferential edge and a recessed hole in the center.

### BRIEF DESCRIPTION OF DRAWINGS

This invention will be better understood by referring to the accompanying drawings, wherein:

FIG. 1 is an exploded perspective view of a conventional step-by-step motor;

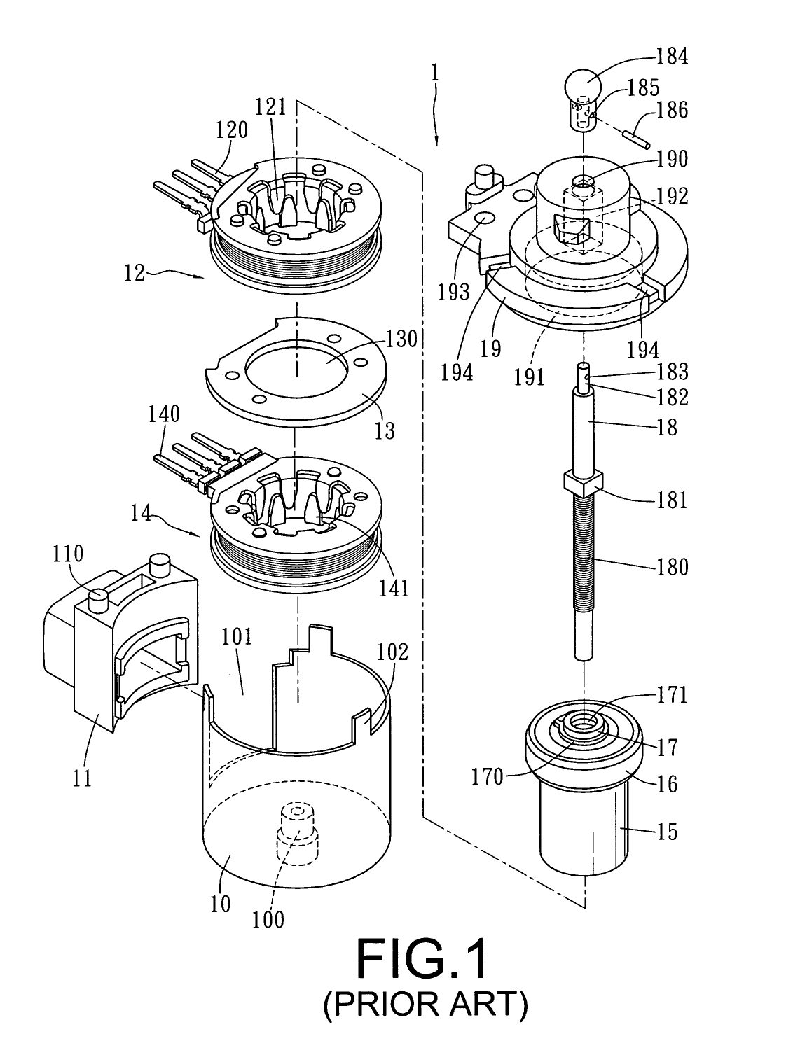

FIG. 2 is a perspective view of the conventional step-by-step motor;

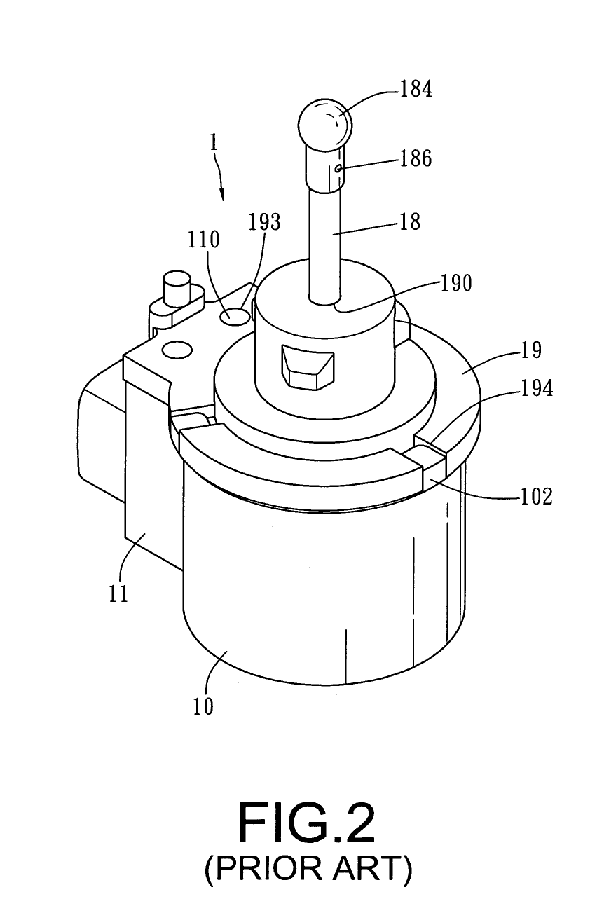

FIG. 3 is a cross-sectional view of the conventional step-by-step motor;

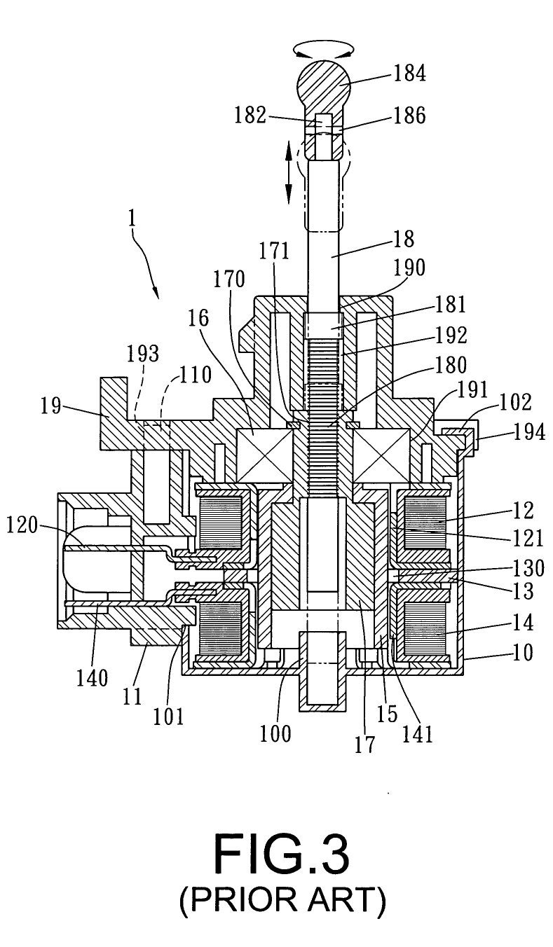

FIG. 4 is an exploded perspective view of a step-by-step motor able to carry out up-and-down motion in the present invention;

FIG. 5 is a perspective view of the step-by-step motor able to carry out up-and-down motion in the present invention; and

FIG. 6 is a cross-sectional view of the step-by-step motor able to carry out up-and-down motion in the present invention.

### DETAILED DESCRIPTION OF THE PREFERRED EMBODIMENT

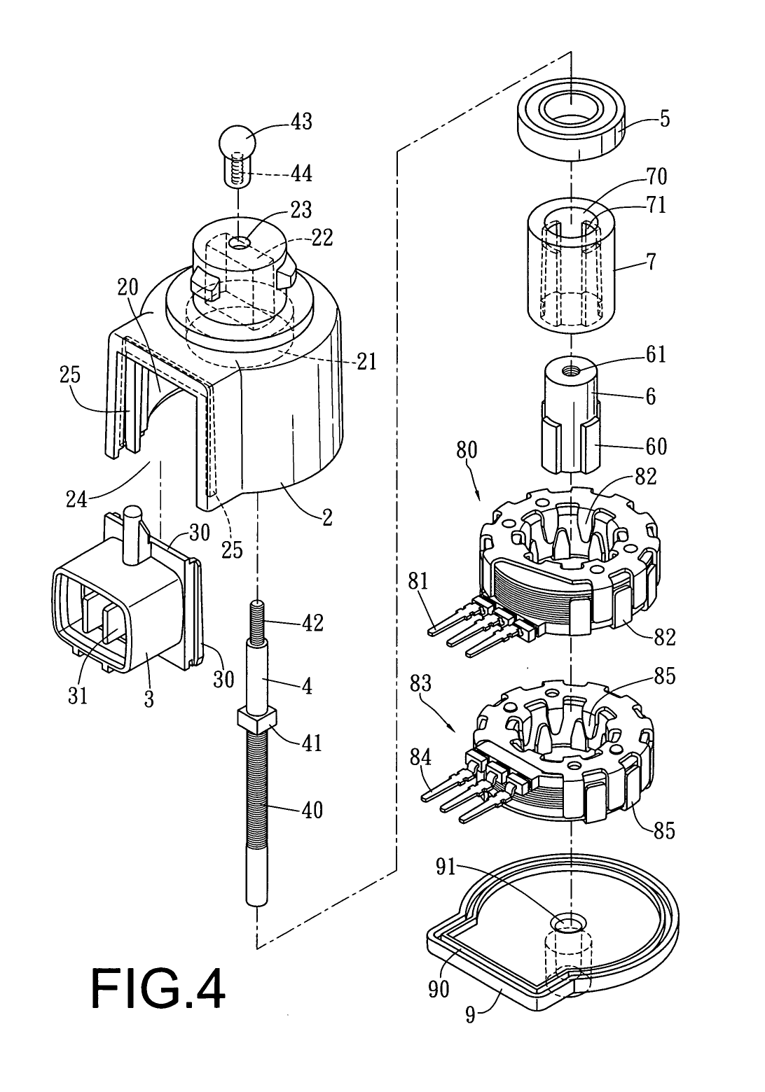

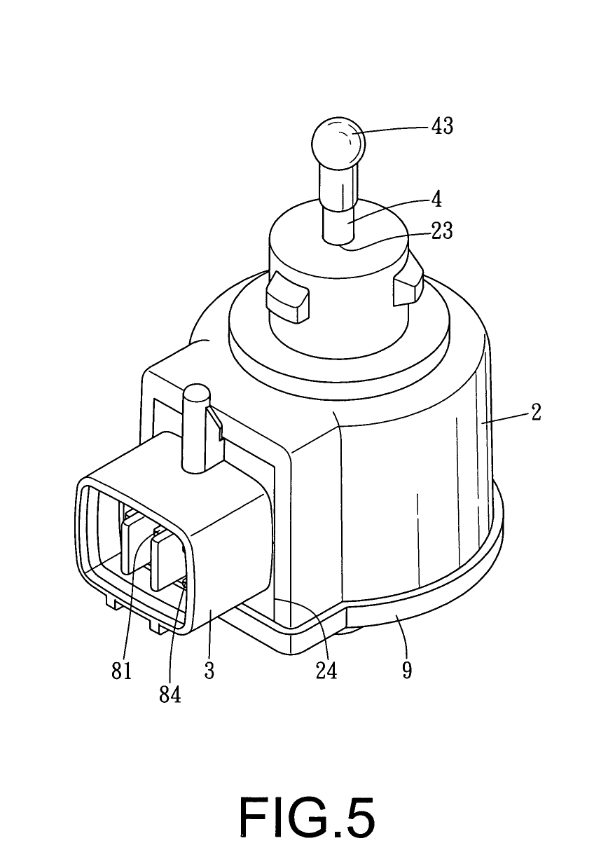

A preferred embodiment of a step-by-step motor able to carry out up-and-down motion in the present invention, as shown in FIGS. 4, 5 and 6, includes a housing 2, a connecting base 3, a top rod 4, a bearing 5, a connecting member 6, a magnet 7, a right-handed coil 80, a reverse coil 83 and a bottom cover 9 combined together.

The housing 2 is formed in the interior with an accommodating chamber 20 provided inside with a recessed chamber 21 with a rectangular slot 22 having its upper side bored with an insert hole 23. The housing 2 further has one sidewall bored with an opening 24 having its inner wall disposed with slide grooves 25.

The connecting base 3 to be assembled on one sidewall of the housing 10 has the peripheral edge of one sidewall disposed with a slide rail 30 and its interior bored with a plurality of connecting holes 31.

The top rod 4 to be inserted through the insert hole 23 of the housing 2 has the section near its lower end formed with male threads 40, its intermediate wall secured thereon with a square stopper 41 and its upper end formed with threads 42, having a locking knob 43 with a lengthwise threaded hole 44 threadably combined with the threaded end 42 of the top rod 4.

The bearing 5 is received in the recessed chamber 21 of the housing 2.

The connecting member 6 to be positioned under the bearing 5 has its upper end inserted through the bearing 5, its lower circumferential wall formed thereon with a plurality of lengthwise projecting members 60 spaced apart and its central portion bored with a threaded hole 61.

The magnet 7 to be fitted around the connecting member 6 is bored in the center with a through insert hole 70 having its inner circumferential wall cut with a plurality of lengthwise positioning grooves 71 spaced apart.

The right-handed coil 80 to be positioned in the accommodating chamber 20 of the housing 2 has one outer side disposed with connecting terminals 81, and its inner and outer circumferential wall respectively covered with claws 82 spaced apart equidistantly.

The reverse coil 83 to be received in the accommodating chamber 20 of the housing 2 and overlapped with the right-handed coil 80 has one outer side fixed with connecting terminals 84, and its inner and outer circumferential wall respectively covered with claw trips 85 spaced apart equidistantly.

The bottom cover 9 to be covered on the bottom of the housing 2 is bored with an annular recess 90 near its circumferential edge and a recessed hole 91 in the center.

In assembling, as shown in FIGS. 4, 5 and 6, firstly, the magnet 7 is fitted around the connecting member 6, letting the projecting members 60 of the connecting member 6 respectively inserted in the positioning grooves 71 of the magnet 7, and then the upper end of the connecting member 6 is forcedly fitted in the bearing 5 to combine the connecting member 6 and the bearing 5 together and also position the magnet 7 on the connecting member 6. Next, the top rod 4 is inserted into the square slot 22 from under the housing 2 to let the square stopper 41 of the top rod 4 positioned in the square slot 22 of the housing 2 and the threaded end 42 of the top rod 4 inserted through the insert hole 23 of the housing 2 and threadably assembled with the locking block 43 to combine the top rod 4 together with the locking knob 43. Subsequently, the top rod 4 has the male threads 40 of the lower section threadably combined with the threaded hole 61 of the connecting member 6, letting the bearing 5 positioned in the recessed chamber 21 of the housing 2 and fixed therein by means of supersonic welding, with the connecting member 6 and the magnet 7 positioned in the accommodating chamber 20 of the housing 2. Afterward, the right-handed coil 80 and the reverse coil 83 are overlapped with each other and have their connecting terminals 81, 84 respectively inserted in the connecting holes 31 of the connecting base 3, and then the right-handed coil 80, the reverse coil 83 and the connecting base 3 are together received in the accommodating chamber 20 of the housing 2, letting the slide rails 30 of the connecting base 3 respectively inserted in the slide grooves 25 of the housing 2. At this time, the connecting base 3 is located in the opening 24 of the housing 2, and the right-handed coil 80 and the reverse coil 83 are fitted around the magnet 7. Lastly, the bottom cover 9 is closed on the bottom of the housing 2, having its annular recess 90 engaged with the bottom edge of the housing 2, and then the bottom cover 9 and the housing 2 are firmly combined together by supersonic welding to finish assembly of the step-by-step motor, able to assemble the step-by-step motor conveniently, quickly and stably.

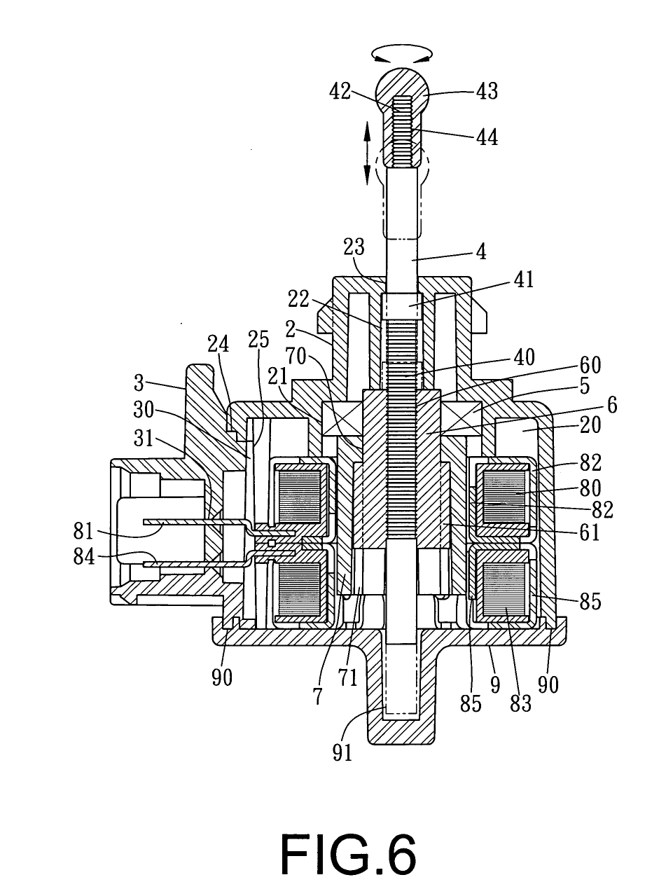

In using, referring to FIG. 6, the connecting base 3 is first connected with an external circuit. To move the top rod 4 upward, the external circuit is controlled to supply the connecting terminals 81 of the right-handed coil 80 with electricity to actuate the magnet 7 and the connecting member 6 to rotate clockwise. At this time, the top rod 4, which is threadably combined with the connecting member 6, but restricted by the square slot 22 of the housing 2 and unable to rotate together with the connecting member 6, can only be moved straight upward by the relative motion of its male threads 40 and the threaded hole 61 of the connecting member 6. To move the top rod 4 downward, the external circuit is controlled to make the connecting terminals 84 of the reverse coil 83 electrically connected to actuate the magnet 7 and the connecting member 6 to rotate counterclockwise. Simultaneously, the top rod 4 threadably combined with the connecting member 6 will be reversely moves straight downward.

As can be understood from the above description, this invention has the following advantages.

1. The right-handed coil 80 and the reverse coil 83 have their inner and outer circumferential wall respectively covered with the claws 82 and 85, able to increase the magnetic permeability of the right-handed coil 80 and the reverse coil 83.

2. The slide groove 25 of the housing 2 and the slide rail 30 of the connecting base 3 enable the housing 2 and the connecting base 3 to be combined together conveniently and with great stability.

3. The housing 2 and the bottom cover 9 are combined together by supersonic welding, able to strengthen the whole structure of the step-by-step motor.

While the preferred embodiment of the invention has been described above, it will be recognized and understood that various modifications may be made therein and the appended claims are intended to cover all such modifications that may fall within the spirit and scope of the invention.

What is claimed is:

1. A step-by-step motor able to carry out up-and-down motion comprising:
a housing formed with an accommodating chamber in the interior, said accommodating chamber provided inside with a recessed chamber, said recessed chamber provided with a rectangular slot, said rectangular slot having its upper side bored with an insert hole, said housing having one side wall bored with an opening, an inner wall defining said opening cut with a slide groove;
a connecting base assembled on one side wall of said housing, said connecting base disposed with a slide rail at one side corresponding with said opening of said housing, said connecting base provided with a plurality of connecting holes in the interior;
a top rod having its upper end inserted through said insert hole of said housing, said top rod having the section near its lower end provided with male threads, said top rod having an intermediate wall fixed thereon with a square stopper, said top rod having said threaded upper end threadably combined with a locking knob;
a bearing positioned in said recessed chamber of said housing;
a connecting member positioned under said bearing and having its upper end inserted through said bearing, said connecting member bored with a threaded hole in the center;
a magnet fitted around said connecting member;
a right-handed coil received in said accommodating chamber of said housing, said right-handed coil having one outer side disposed with connecting terminals, said right-handed coil having its inner and outer circumferential wall respectively covered with claws spaced apart;
a reverse coil received in said accommodating chamber of said housing and overlapped with said right-handed coil, said reverse coil having one outer side secured with parallel connecting terminals, said reverse coil having its inner and outer circumferential wall respectively covered with claws spaced apart; and
a bottom cover closed on a bottom of said housing, said bottom cover provided with an annular recess near its circumferential edge, said bottom cover bored with a recessed hole in the center.

2. The step-by-step motor able to carry out up-and-down motor as claimed in claim 1, wherein said top rod has its upper end formed with threads, and said locking knob is bored with a lengthwise threaded hole, said locking knob threadably combined with said threaded end of said top rod.

3. The step-by-step motor able to carry out up-and-down motor as claimed in claim 1, wherein said connecting member has its lower outer circumferential wall formed with a plurality of lengthwise projecting members spaced apart, and said magnet is bored in the center with an insert hole having its inner circumferential wall bored with a plurality of lengthwise positioning grooves spaced apart.
